(19) United States
(12) Patent Application Publication
(10) Pub. No.: US 2010/0257314 A1
(43) Pub. Date: Oct. 7, 2010

(54) Remote Updating Memory

(76) Inventor: Douglas James Gorny, Boulder, CO (US)

Correspondence Address: Douglas J. Gorny, 6310 Bruntwood Court, Boulder, CO, 80303, US

(21) Appl. No.: 12/571,332

(22) Filed: Sep. 30, 2009

Related U.S. Application Data
(60) Provisional application No. 61/103,031, filed on Oct. 6, 2008.

(51) Int. Cl. G06F 12/00

(52) U.S. Cl. 711/115; 711/E12.001

(57) ABSTRACT

A system for remotely updating the storage in removable memory devices is described. These remote updating memory devices are particularly useful to support legacy and cost-reduced operational devices in additional or enhanced applications. The primary goal is to provide a removable memory device which does not need to be physically removed from its operational device during update. A remote interface on the removable memory device allows the removable memory device's storage to be updated without affecting the established physical interface.

### BACKGROUND OF THE INVENTION

The invention relates to removable memory devices and the ability to update them using a remote interface.

Consumer devices, including but not limited to digital cameras, digital video recorders, digital picture frames, televisions, memory card readers which convert to television-compatible signals, video games, printers, phones, personal data assistants, and music playback and recording devices, often use removable memory devices to store and load their data. Industrial and military devices also use removable memory devices. The term operational device will be used to cover all such devices which use removable memory devices. Further devices which exchange data with devices which use removable memory devices, such as personal computers, will also be referred to as operational devices.

These removable memory devices can be but are not limited to compact flash cards, flash drives, memory sticks, and memory units with standard wired interfaces such as USB, IEEE1394, and eSata. These will be referred to as removable memory devices.

The interfaces between operational devices and removable memory devices requiring mechanical connection to form an electrical interface will be referred to as physical interfaces. These include but are not limited to all USB connector types and all compact flash card connector types.

The interface between the operational device and a remote updating memory device, which is not a physical interface, will be referred to as the remote interface. Wired versions of remote interfaces include but are not limited to USB, IEEE1395, and eSata. Wireless versions of remote interfaces include but are not limited to all WiFi versions, Bluetooth, and infrared.

Memory devices have elements to retain the data transferred from an interface. These elements will be referred to as storage. Storage elements which retain their data without an active power source will be referred to as nonvolatile storage. Storage elements which do not retain their data without an active power source will be referred to as volatile storage.

Devices containing one or more forms of storage, one or more forms of physical interface, and one or more forms of remote interface, will be referred to as remote updating memory devices or the invention. These remote updating memory devices are powered using the physical interface in the same fashion as removable memory devices. It is also possible but not necessary to provide additional power for remote interface operations using a wired remote interface or battery located in the remote updating memory device itself.

To exchange data between two or more operational devices, a removable memory device needs to be physically attached to the first operational device, have its data manipulated by the first operational device, be physically removed from the first operational device, be physically attached to the second operational device, and have its data manipulated by the second operational device. Subsequent transfers require the same physical processes. This physical manipulation reduces the lifetime of the removable memory device's and the operational devices' interface connectors. Often removable memory devices need to be properly shut down prior to removal from the operational device, adding additional time to the data transfer. Additionally, the operational device may require a proper start-up sequence to be executed prior to using the removable memory device.

Operational devices exchanging data which are not physically close to one another add the additional burden of transporting the removable memory device between the operational devices.

Removable memory devices have gotten increasingly larger in capacity in order to handle the increasing size of the data they need to transfer between operational devices. Due to the fore-mentioned physical manipulation of the removable memory device to transfer data, it is beneficial to use large capacity removable memory devices to reduce the number of times physical manipulation is required. This increases the cost of the removable memory device and requires that the operational devices be designed to support these larger capacity removable memory devices.

Removable memory devices not employing data encryption schemes can be accessed by most operational devices sharing a common physical interface. Removable memory devices employing data encryption schemes need to share passwords or keys between operational devices in order to transfer data, which can compromise the privacy of the passwords and keys.

Data intended to be shared between two or more operational devices often needs to be deleted from the removable memory device prior to sharing data between more operational devices using the same removable memory device. This is done in order to preserve the privacy of the data in the prior transfers.

### BRIEF SUMMARY OF THE INVENTION

A novel approach whereby a removal memory device can be updated remotely will reduce the problems arising from conventional removable memory devices. Once physically attached and properly started in an operational device, the remote updating memory device can be left in that state. The other operational device(s) then can alter the data on the remote updating memory device remotely, not using the memory device's physical interface(s). Many operational sources, either due to function like personal computers or due to being more modern like high definition video recorders, have built-in remote communication interfaces such as WiFi, Bluetooth, USB, IEEE1394, etc., and can transfer data remotely with no or minor modification. A remote updating memory device with one or more of these remote interfaces can then be updated remotely by operational device(s) with compatible remote interfaces while maintaining a physical interface to another operational device. The physically interfaced operational device can then use the updated data in the same fashion as if remote updating memory was a removable memory device employing only a physical interface. The physical and remote access to the remote updating memory storage will be referred to as simultaneous; however, access resembling simultaneous can be obtained by alternating interface access to the storage and using buffers and arbitration to make the access appear continuous to each interface.

An example would be a personal computer providing image data to a digital picture frame using a USB Type A physical interface on a removable memory device, often referred to as a flash drive. Typical operation would require the flash drive to be inserted into the personal computer's USB port, have image data stored, have the flash drive properly removed, have the flash drive inserted into the digital picture frame's USB port, and have some user action to inform the digital picture frame of the new image data to be displayed. Transfers of new image data would require the flash drive to be properly removed from the digital picture frame's USB port and the fore-mentioned process repeated. A USB flash drive supporting a remote interface communication method such as WiFi could be inserted into the digital picture frame's USB port and started once. The personal computer would then communicate with the flash drive using its WiFi remote communication. Different image data could be transferred from the personal computer to the digital picture frame at automatic time intervals, when new data is added to the personal computer or when invoked by the user without physically manipulating the flash drive. The storage capacity of the flash drive can be reduced to store only enough image data to keep the digital picture frame updating smoothly between transfers. In a sense the remote updating memory device is acting as more of a buffer and less of an actual mass storage device. The digital picture frame should not need to be informed of the transfer if set to the proper mode. In other words, it will read and display the new image data as if it had been on the remote updating memory device prior to establishing the physical interface and the activation of image display.

In addition to the fore-mentioned benefits related to physical manipulation and storage size, a remote updating memory device can provide an interface between two operational devices which do not have a common interface. Interface translation devices such USB compact flash card readers are often required to facilitate an operational device transfer to a removable memory device. Using a remote updating memory device allows the user to select the remote updating device which has the physical interface supported by one or more of their operational devices and a remote interface supported by one or more of their other operational devices between which they will be transferring data. This is key in supporting legacy devices which have physical and remote interfaces no longer being integrated into more modern operational devices.

Security issues associated with data transfer using removable memory devices can be alleviated by using remote updating memory devices. Data can be exchanged without removing the remote updating memory device or sharing wireless/wired security codes. Only the operational device using the remote interface requires security with the remote updating memory device. The operational device using the physical interface does not require any security measures due to the physical nature of the connection preventing wireless or wired eavesdropping. Further, if the remote updating memory device uses volatile storage, then the data shared will be erased when the remote updating memory device is disconnected from its physical interface. It should be noted that this automatic erasure is only relevant to remote updating memory devices without a built-in or remote interface power source; in other words, their power is obtained from the operational device using the physical interface. Nonvolatile storage on a remote updating memory device can be partitioned to only allow certain data to be accessible to the physical interface(s). Remote interface(s) would have access to the entire nonvolatile storage and be able to designate which data is accessible by the physical interface(s). This partitioning of nonvolatile storage on a remote updating memory device allows data to be made accessible and inaccessible by the physical interface(s) without the need to again transfer the data across the remote interface(s).

In summary, remote updating memory provides benefits including reduced physical manipulation, reduced storage capacity requirements, remote and physical interface flexibility, and enhanced security benefits.

### BRIEF DESCRIPTION OF THE DRAWINGS

The present invention is illustrated by way of example and not by limitation in the accompanying figures, in which like reference numerals indicate similar elements and in which:

FIG. 1 is a simplified usage diagram of the prior art of a removable memory device.

FIG. 2 is a simplified diagram of the proposed remote updating memory device.

### DETAILED DESCRIPTION OF THE INVENTION

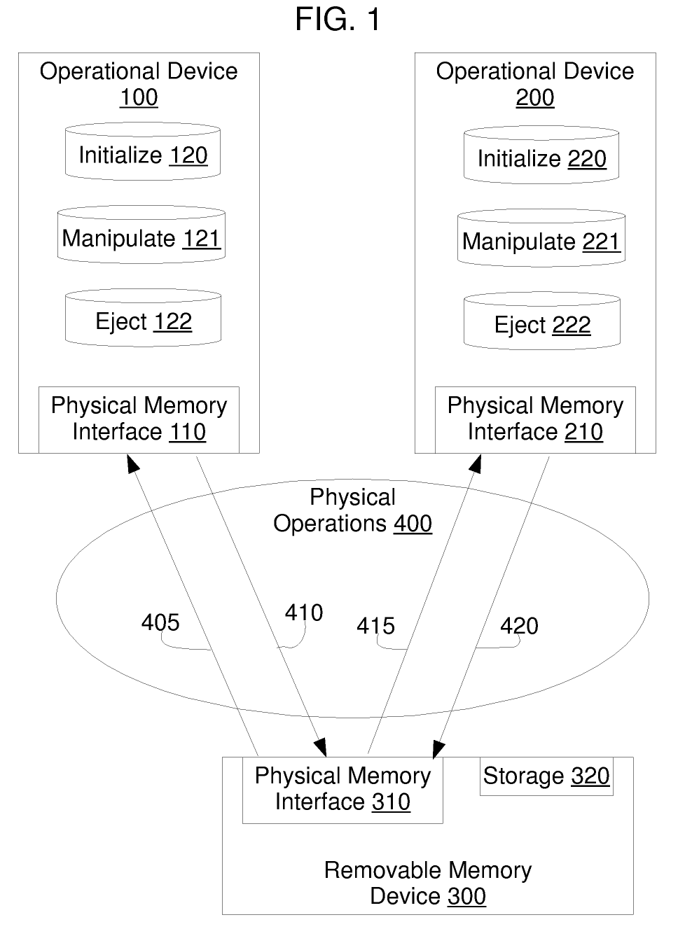

The prior art design is illustrated in FIG. 1. Removable memory device 300 is used to transfer data between operational devices 100 and 200. All three devices support a common or compatible physical memory interface designated by 110, 210, and 310. A typical data transfer would involve the following sequence: removable memory device 300 is interfaced to operational device 100 using their compatible physical memory interfaces 110 and 310 shown as physical insertion 405, an initialization 120 takes place on 100 making the interface active and ready to manipulate the data in 300, a data manipulation 121 takes place to alter or read the data on 300 located in storage 320, an eject or closing operation 122 occurs to deactivate the interface, the physical memory device 300 is removed from physical memory interface 110 shown as physical removal 410, the physical memory device 300 is interfaced to operational device 200 using their compatible physical memory interfaces 210 and 310 shown as physical insertion 415, an initialization 220 takes place on 200 making the interface active and ready to manipulate the data in 300, a data manipulation 221 takes place to alter or read the data on 300 located in storage 320, and an eject or closing operation 122 would need to occur to deactivate the interface prior to subsequent transfers of data and removal from physical memory interface 210 shown as physical removal 420.

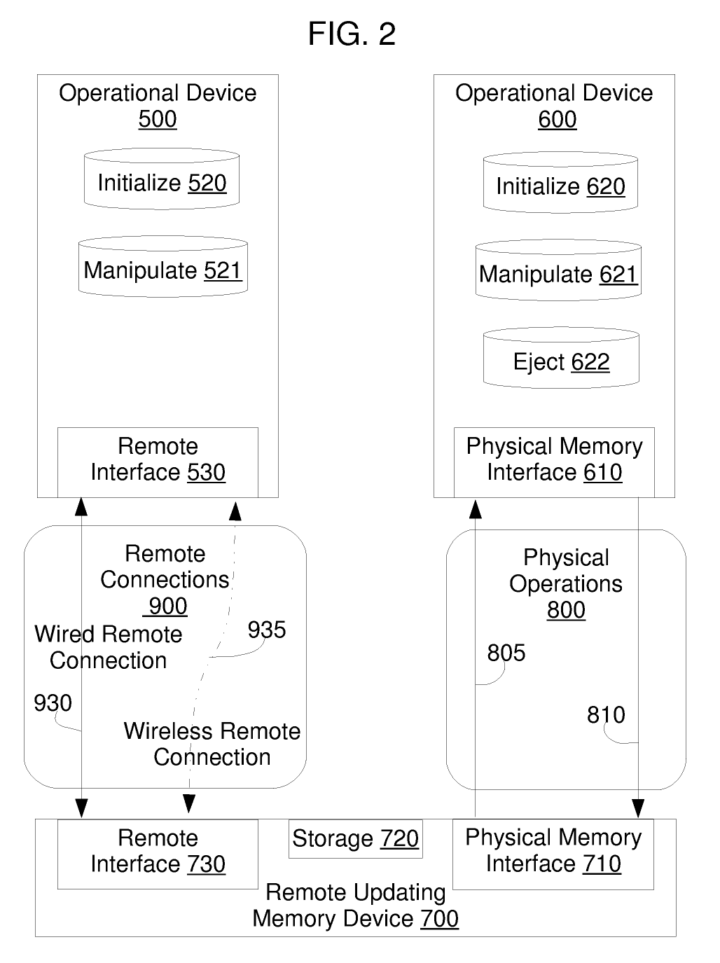

An example of the invention is illustrated in FIG. 2. Remote updating memory device 700 is used to transfer data between operational devices 500 and 600. Devices 600 and 700 support a common or compatible physical memory interface designated by 610 and 710. Devices 500 and 700 support a common or compatible remote interface designated by 530 and 730. A typical data transfer would involve the following sequence: remote updating memory device 700 is interfaced to operational device 600 using their compatible physical memory interfaces 610 and 710 shown as physical insertion 805, an initialization 620 takes place on 600 making the physical interface active and ready to manipulate the data in 700, a data manipulation 621 takes place to alter or read the data on 700 located in storage 720, the physical memory 700 is interfaced to operational device 500 using their compatible remote interface 530 and 730 shown as either a wired remote connection 930 or a wireless remote connection 935, an initialization 520 takes place on 500 making the remote interface active and ready to manipulate the data in 700, a data manipulation 521 takes place to alter or read the data on 700 located in storage 720, and subsequent data transfers between operational devices 500 and 600 through 700 only require the use of data manipulations 521 and 621. Should remote updating memory device 700 be desired to be removed from operational device 600, then an eject or closing operation 622 would need to occur to deactivate the interface between 610 and 710 prior to detachment shown as physical removal 810.

The above is not intended to be limiting. It will be apparent to those of ordinary skill in the art that modifications thereto can be made without departure from the spirit and scope of the invention as set forth by the claims of this invention.

There are examples of remote interfaces being used to update storage in operational devices; however, they differ from the invention in scope and function.

U.S. Pat. No. 7,376,757 differs in that it is using the physical interface of the removable memory device to accommodate additional functionality in operational devices not directly supporting that additional functionality.

US Patent Application 20040225796 differs in that it provides a means to adapt the physical interfaces of removable memory devices using other physical interfaces.

U.S. Pat. No. 6,871,245 differs in that it is using the memory device as a means to translate between two file systems.

U.S. Pat. No. 7,340,275 differs in that it is taking data from the storage written by the physical connection and transferring over the remote interface for the purposes of data backup and to accommodate for poor remote interface reliability.

U.S. Pat. No. 7,187,947 differs in that it uses the memory to buffer audio information on a cellular phone.

U.S. Pat. No. 6,976,073 differs in that it is a connection interface between an appliance and a storage device.

U.S. Pat. No. 5,974,312 differs in that it updates the program and user setting storage of wireless devices.

U.S. Patent Application 20030216954 differs in that it is remotely updating memory devices specifically for exchanging marketing data.

What is claimed is:

1. A system for facilitating data transfer comprising:
storage composed of one or more volatile and/or nonvolatile storage elements;
one or more physical interfaces providing data access to the storage; and
one or more remote interfaces providing security, data, and control access to the storage.

2. The system and method in claim 1, wherein the storage capacity is reduced from that of a standard removable memory device yet retains that same functionality and performance due to the remote updating capability.

3. The system and method in claim 1, wherein the storage is all or partially nonvolatile and partitioned into sections accessible by the physical interface(s) and sections not accessible by the physical interface(s), and said data partitioning is controlled by the remote interface(s).
